(19) United States
(12) Patent Application Publication
(10) Pub. No.: US 2014/0347346 A1
(43) Pub. Date: Nov. 27, 2014

(54) DISPLAY DRIVER INTEGRATED CIRCUIT AND A DISPLAY SYSTEM INCLUDING THE SAME

(71) Applicant: SAMSUNG ELECTRONICS CO., LTD., Gyeonggi-do (KR)

(72) Inventors: Sang-Won HAN, Gyeonggi-do (KR); Jaehyuck Woo, Gyeonggi-do (KR); Byunghun Han, Seoul (KR)

(73) Assignee: SAMSUNG ELECTRONICS CO., LTD., Gyeonggi-do (KR)

(21) Appl. No.: 14/188,782

(22) Filed: Feb. 25, 2014

(30) Foreign Application Priority Data
May 27, 2013 (KR) 10-2013-0059850

(51) Int. Cl. G09G 3/34

(52) U.S. Cl. CPC G09G 3/34
USPC 345/213

(57) ABSTRACT

A display driver integrated circuit includes a gate driving unit configured to control voltages of a plurality of gate lines connected to a display panel, a voltage boosting unit configured to supply a gate voltage to the gate driving unit, and a control logic, unit configured to receive data, a horizontal synchronization signal, and a vertical synchronization signal, generate a gate control signal based on the data, the horizontal synchronization signal, and the vertical synchronization signal, and transfer the gate control signal to the gate driving unit and the voltage boosting unit. The voltage boosting unit adjusts a level of the gate voltage based on the gate control signal.

### CROSS-REFERENCE TO RELATED APPLICATION

This application claims priority under 35 U.S.C. §119 to Korean Patent Application No. 10-2013-0059850, filed on May 27, 2013, the disclosure of which is incorporated by reference herein in its entirety.

### TECHNICAL FIELD

Exemplary embodiments of the present inventive concept relate to a display apparatus, and more particularly, to a display driver integrated circuit and a display system including the same.

### DISCUSSION OF THE RELATED ART

A display apparatus uses a digital signal including image information to generate signals through a display panel so that a user can view an image. With the development of display technology, flat panel displays (FPDs) such as liquid crystal displays (LCDs), plasma display panels (PDPs), field emission displays (FEDs), electroluminescent displays (ELDs), light emitting diodes (LEDs), and vacuum fluorescent displays (VFDs) have been used in the fields of mobile phones, digital cameras, and mobile devices, for example.

A display driver integrated circuit (DDI) used in an FPD includes a voltage booster for receiving an external voltage and pumping the received external voltage with a predetermined boosting multiplier. Voltage output from the voltage booster is supplied to a display panel by a gate driving unit. A typical voltage booster determines a boosting multiplier according to a change of input voltage. However, in this case, if the output voltage of the voltage booster temporarily decreases when a load occurs in a display panel, image quality can be degraded and voltage efficiency can be reduced.

### SUMMARY

An exemplary embodiment of the present inventive concept provides a display driver integrated circuit for adjusting a boosting multiplier according to a change of a load in a display panel, and a display system to which the display driver integrated circuit is applied.

According to an exemplary embodiment of the present inventive concept, a display driver integrated circuit includes a gate driving unit configured to control voltages of a plurality of gate lines connected to a display panel, a voltage boosting unit configured to supply a gate voltage to the gate driving unit, and a control logic unit configured to receive data, a horizontal synchronization signal, and a vertical synchronization signal, generate a gate control signal based on the data, the horizontal synchronization signal, and the vertical synchronization signal, and transfer the gate control signal to the gate driving unit and the voltage boosting unit, wherein the voltage boosting unit is configured to adjust a level of the gate voltage based on the gate control signal.

In exemplary embodiments of the present inventive concept, the gate driving unit may supply the gate voltage to at least one of the plurality of gate lines based on the gate control signal.

In exemplary embodiments of the present inventive concept, the voltage boosting unit is configured to increase the gate voltage when the gate voltage is applied to the at least one of the plurality of gate lines.

In exemplary embodiments of the present inventive concept, the voltage boosting unit comprises an XOR gate configured to receive the gate control signal, perform an exclusive OR operation on the gate control signal and output an operation value as a result of the exclusive OR operation, a signal generator configured to receive the operation value of the XOR gate and output first and second mode control signals based on the operation value, and a charge pump configured to output the gate voltage based on the first and second mode control signals, wherein the first and second mode control signals are complementary signals.

In exemplary embodiments of the present inventive concept, the charge pump is configured to output a first gate voltage when the first mode control signal is in a first state, and to output a second gate voltage when the second mode control signal is in the first state, wherein the first gate voltage may be lower than the second voltage.

In exemplary embodiments of the present inventive concept, the display driver integrated circuit further comprises a source driving unit configured to control a current of a plurality of source lines connected to the display panel under control of the control logic unit, and a graphic random access memory (RAM) configured to support a serial interface between an external device and the control logic unit.

In exemplary embodiments of the present inventive concept, the voltage boosting unit is configured to receive an automatic control signal and a mode selection signal, to adjust an operating mode of the voltage boosting unit based on the automatic control signal and the mode selection signal, and to adjust the level of the gate voltage based on the adjusted operating mode.

In exemplary embodiments of the present inventive concept, the voltage boosting unit is configured to adjust a boosting multiplier based on the mode selection signal when the automatic control signal is in a first state, and the voltage boosting unit is configured to adjust the level of the gate voltage based on the gate control signal when the automatic control signal is in a second state.

According to an exemplary embodiment of the present inventive concept, a display system includes a display panel connected to a plurality of gate lines and a plurality of source lines, and a display driver integrated circuit configured to control a voltage of the plurality of gate lines and a current of the plurality of source lines, wherein the display driver integrated circuit is configured to receive an image signal, to generate a gate control signal based on the image signal, and to adjust a level of a gate voltage to be supplied to the plurality of gate lines based on the gate control signal.

In exemplary embodiments of the present inventive concept, the display driver integrated circuit includes a control logic unit configured to output the gate control signal based on the image signal, a gate driving unit configured to control the voltage of the plurality of gate lines based on the gate control signal, and a voltage boosting unit configured to adjust the level of the gate voltage based on the gate control signal.

In exemplary embodiments of the present inventive concept, the gate control signal may include control signals corresponding to the plurality of gate lines respectively.

In exemplary embodiments of the present inventive concept, the gate voltage may be supplied to at least one of the plurality of gate lines when a result of an exclusive OR operation on the gate control signal is a first value, and the display driver integrated circuit is configured to increase the level of the gate voltage when the gate control signal is in a first state.

In exemplary embodiments of the present inventive concept, the display driver integrated circuit further includes a source driving unit configured to control a current of at least one of the plurality of source lines.

In exemplary embodiments of the present inventive concept, the display driver integrated circuit further includes a graphic RAM configured to support a serial interface with an external device.

In exemplary embodiments of the present inventive concept, the display panel may be an organic light emitting display panel, a liquid crystal display panel, a plasma display panel, an electrophoretic display panel, or an electrowetting display panel.

According to an exemplary embodiment of the present inventive concept, a display driver integrated circuit includes a control logic unit configured to generate a gate control signal in response to image information; a voltage boosting unit configured to output a gate voltage in response to first and second input voltages and adjust a boosting multiplier of the gate voltage in response to the gate control signal received from the control logic unit; and a gate driving unit configured to receive the gate voltage from the voltage boosting unit and output the gate voltage in response to the gate control signal received from the control logic unit.

The boosting multiplier of the gate voltage is adjusted when a load occurs in a display panel.

The boosting multiplier is increased when it is adjusted.

The voltage boosting unit includes a logic gate configured to receive the gate control signal.

The voltage boosting unit includes a charge pump configured to receive the first and second input voltages and to receive a mode control signal generated in response to an output of the logic gate.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram illustrating a display system according to an exemplary embodiment of the present inventive concept.

FIG. 2 is a block diagram illustrating a display driver integrated circuit (DDI) of FIG. 1, according to an exemplary embodiment of the present inventive concept.

FIG. 3 is a block diagram illustrating a voltage boosting unit of FIG. 2, according to an exemplary embodiment of the present inventive concept.

FIG. 4 is a block diagram illustrating a charge pump of FIG. 3, according to an exemplary embodiment of the present inventive concept.

FIG. 5 is a graph illustrating a gate voltage of FIG. 1, according to an exemplary embodiment of the present inventive concept.

FIG. 6 is a block diagram illustrating a DDI according to an exemplary embodiment of the present inventive concept.

FIG. 7 is a block diagram illustrating a voltage boosting unit of FIG. 6, according to an exemplary embodiment of the present inventive concept.

FIG. 8 is a block diagram illustrating a DDI according to an exemplary embodiment of the present inventive concept.

FIG. 9 is a block diagram illustrating a voltage boosting unit of FIG. 8, according to an exemplary embodiment of the present inventive concept.

FIG. 10 is a block diagram illustrating a display system to which a DDI according to an exemplary embodiment of the present inventive concept is applied;

FIG. 11 is a block diagram illustrating a user system to which a DDI according to an exemplary embodiment of the present inventive concept is applied; and

FIG. 12 is a block diagram illustrating a mobile system to which a display system according to an exemplary embodiment of the present inventive concept is applied.

### DETAILED DESCRIPTION OF THE EMBODIMENTS

Hereinafter, exemplary embodiments of the present inventive concept will be described with reference to the accompanying drawings. Like reference numerals may refer to like elements throughout the accompanying drawings.

As used herein, the singular forms “a”, “an” and “the” are intended to include the plural forms as well, unless the context clearly indicates otherwise.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present.

A display driver integrated circuit according to an exemplary embodiment of the present inventive concept includes a voltage boosting unit for adjusting a boosting multiplier of a gate voltage according to a load variation. Accordingly, a voltage efficiency of a display system improves, and thus, the display driver integrated circuit and the display system to which the display driver integrated circuit is applied may have improved performance.

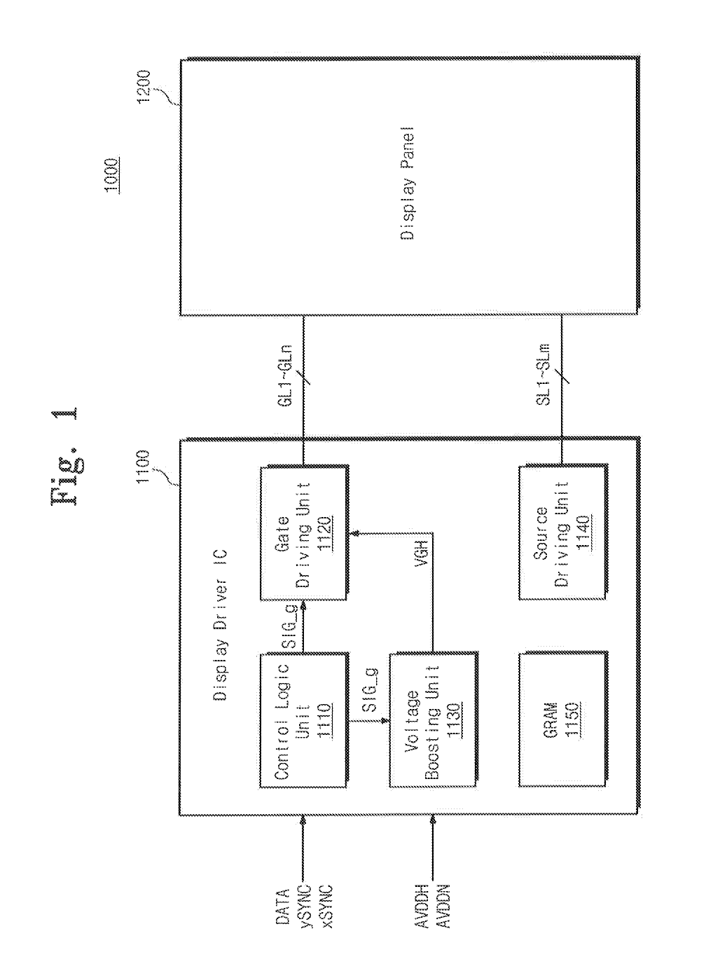

FIG. 1 is a block diagram illustrating a display system according to an exemplary embodiment of the present inventive concept. Referring to FIG. 1, a display system 1000 includes a display driver integrated circuit (DDI) 1100 and a display panel 1200.

The DDI 1100 may include a control logic unit 1110, a gate driving unit 1120, a voltage boosting unit 1130, a source driving unit 1140, and a graphic random access memory (GRAM) 1150. The DDI 1100 may be a single chip or module.

The control logic unit 1110 may receive data DATA, a vertical synchronization signal ySYNC, and a horizontal synchronization signal xSYNC from an external device (e.g., a host, an application processor, etc.). In exemplary embodiments of the present inventive concept, the data DATA may be a digital signal including image information. The control logic unit 1110 may control the gate driving unit 1120 and the source driving unit 1140 based on the data DATA, the vertical synchronization signal ySYNC, and the horizontal synchronization signal xSYNC.

The gate driving unit 1120 may adjust a voltage of a plurality of gate lines connected to the display panel 1200 under control of the control logic unit 1110. For example, the gate driving unit 1120 may receive a gate control signal SIG_g from the control logic unit 1110. The gate driving unit 1120 may select at least one of a plurality of gate lines GL1 to GLn based on the received gate control signal SIG_g, and may supply a gate voltage to the at least one selected gate line,

The voltage boosting unit 1130 may receive first and second input voltages AVDDH and AVDDN from an external device, and may output a gate voltage based on the received first and second input voltages AVDDH and AVDDN. In exemplary embodiments of the present inventive concept, the voltage boosting unit 1130 may receive the gate control signal SIG_g from the control logic unit 1110, and may adjust a boosting multiplier of the gate voltage based on the received gate control signal SIG_g. For example, the voltage boosting unit 1130 may operate in one of first and second operating modes. The boosting multiplier of the first operating mode is smaller than that of the second operating mode. The voltage boosting unit 1130 may detect a time at which the gate voltage is supplied to at least one of the plurality of gate lines GL1 to GLn based on the gate control signal SIG_g, and may change an operating mode. The voltage boosting unit 1130 may adjust the boosting multiplier of the gate voltage based on the operating mode. A configuration and an operation of the voltage boosting unit 1130 will be described in detail later.

The source driving unit 1140 may select at least one of a plurality of source lines SL1 to SLm connected to the display panel 1200 and may adjust a current of the selected source line under control of the control logic unit 1110.

The GRAM 1150 may be a buffer memory for supporting a high-speed serial interface between the DDI 1100 and an external device. For example, the GRAM 1150 may temporarily store the data DATA received from the external device, and may output the stored data by a scan operation.

The display panel 1200 may output data in units of frames under control of the DDI 1100. The display panel 1200 may include any one of a plurality of flat display panels such as an organic light emitting display (OLED) panel, a liquid crystal display (LCD) panel, a plasma display panel (PDP), an electrophoretic display panel, and an electrowetting display panel.

The display panel 1200 includes a plurality of light emitting devices. The plurality of light emitting devices are respectively connected to the plurality of gate lines GL1 to GLn and the plurality of source lines SL1 to SLm. The DDI 1100 may control outputs of the plurality of light emitting devices by controlling a voltage and a current of the plurality of gate lines GL1 to GLn and the plurality of source lines SL1 to SLm.

According to the above-described exemplary embodiment of the present inventive concept, the voltage boosting unit 1130 may detect an occurrence of a load in the display panel 1200 based on the gate control signal SIG_g received from the control logic unit 1110. At this time, when the load occurs in the display panel 1200, the voltage boosting unit 1130 may increase the boosting multiplier by changing the operating mode. Accordingly, a voltage efficiency of the display system 1000 improves. Therefore, a DDI with improved performance and a display system to which the DDI is applied are provided.

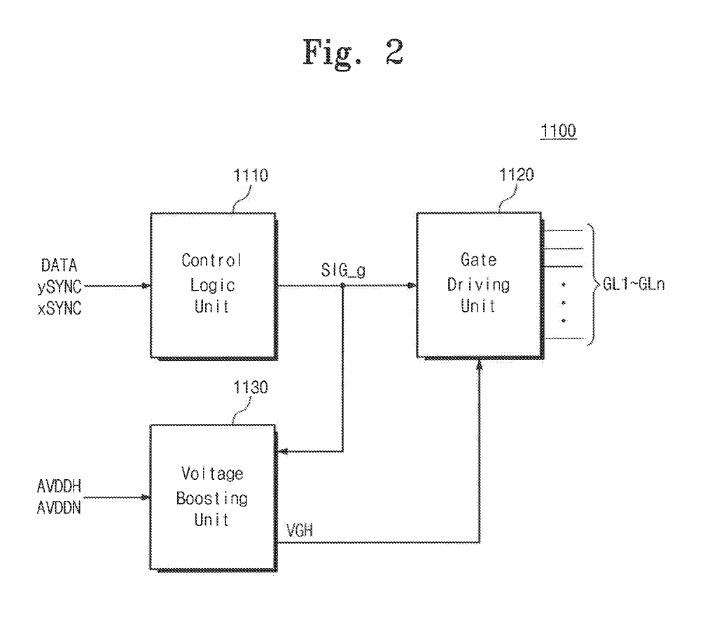

FIG. 2 is a block diagram illustrating the DDI 1100 of FIG. 1, according to an exemplary embodiment of the present inventive concept. For ease of description, the elements of the DDI 1100 other than the control logic unit 1110, the gate driving unit 1120, and the voltage boosting unit 1130 are omitted. However, an exemplary embodiment of the present inventive concept is not limited thereto. Referring to FIGS. 1 and 2, the DDI 1100 includes the control logic unit 1110, the gate driving unit 1120, and the voltage boosting unit 1130.

The control logic unit 1110 may receive the data DATA, the vertical synchronization signal ySYNC, and the horizontal synchronization signal xSYNC from an external device. The control logic unit 1110 may output the gate control signal SIG_g based on the data DATA, the vertical synchronization signal ySYNC, and the horizontal synchronization signal xSYNC For example, the control logic unit 1110 transfers the gate control signal SIG_g to the gate driving unit 1120 and the voltage boosting unit 1130. For example, the gate control signal SIG_g may include a plurality of control signals corresponding to the plurality of gate lines GL1 to GLn.

The gate driving unit 1120 may select at least one of the plurality of gate lines GL1 to GLn and may supply a gate voltage VGH to the selected gate line based on the gate control signal SIG_g received from the control logic unit 1110.

The voltage boosting unit 1130 may receive the first and second input voltages AVDDH and AVDDN from an external device. In exemplary embodiments of the present inventive concept, the first input voltage may be a positive voltage and the second input voltage may be a negative voltage, The voltage boosting unit 1130 may receive the gate control signal SIG_g from the control logic unit 1110. The voltage boosting unit 1130 may detect a time at which the gate voltage VGH is supplied to at least one of the plurality of gate lines GL1 to GLn based on the gate control signal SIG_g. In other words, the voltage boosting unit 1130 may detect a time at which a load occurs in the display panel 1200 based on the gate control signal SIG_g.

When a load occurs in the display panel 1200 (e.g., when the gate voltage VGH is supplied to at least one of the plurality of gate lines GL1 to GLn), the voltage boosting unit 1130 may change the boosting multiplier of the gate voltage VGH. For example, the voltage boosting unit 1130 may operate in the first operating mode. When a load occurs in the display panel 1200, the voltage boosting unit 1130 may operate in the second operating mode. A boosting multiplier of the first operating mode is smaller than that of the second operating mode.

In other words, when the load occurs in the display panel 1200, the voltage boosting unit 1130 may improve the voltage efficiency of the display system 1000 by increasing the boosting multiplier of the gate voltage VGH. Furthermore, a recovery time of the gate voltage VGH is reduced. Therefore, a DDI with improved performance and a display system to which the DDI is applied are provided.

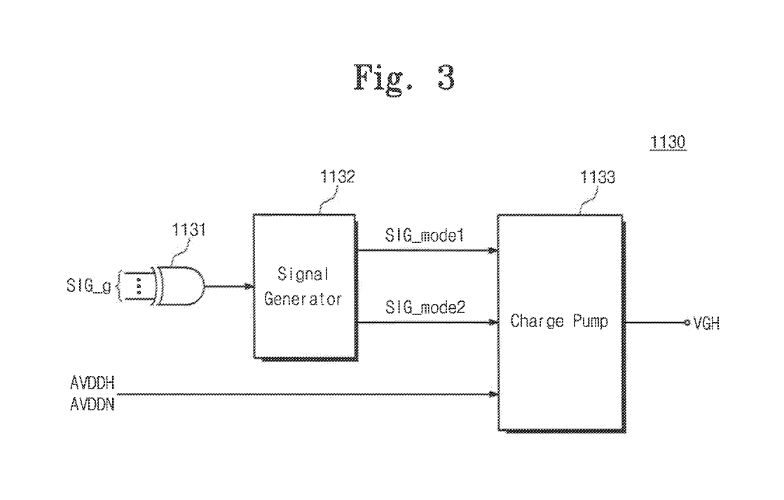

FIG. 3 is a block diagram illustrating the voltage boosting unit 1130 of FIG. 2, according to an exemplary embodiment of the present inventive concept. Referring to FIG. 3, the voltage boosting unit 1130 includes an XOR gate 1131, a signal generator 1132, and a charge pump 1133. The XOR gate 1131 may receive the gate control signal SIG_g. In exemplary embodiments of the present inventive concept, the gate control signal SIG_g may include the plurality of control signals corresponding to the plurality of gate lines GL1 to GLn, respectively. The XOR gate 1131 performs a logical exclusive OR operation on the received gate control signal SIG_g and transfers an operation result value to the signal generator 1132. In exemplary embodiments of the present inventive concept, when the gate voltage VGH is applied to at least one of the plurality of gate lines GL1 to GLn, the operation result value may be a logic high value. On the contrary, when the gate voltage VGH is not applied to the plurality of gate lines GL1 to GLn, the operation result value may be a logic lour value.

In other words, the operation result value may be the logic high value when the load occurs in the display panel 1200, and the operation result value may be the logic low value when the load does not occur in the display panel 1200.

The signal generator 1132 outputs first and second mode control signals SIG_mode1 and SIG_mode2 based on the operation result value received from the XOR gate 1131. For example, when the operation result value is the logic low value (when the load does not occur in the display panel 1200), the first mode control signal SIG_mode1 may be in a logic high state and the second mode control signal SIG_mode2 may be in a logic low state. Here, the voltage boosting unit 1130 operates in the first operating mode.

On the contrary, when the operation result value is the logic high value (when the load occurs in the display panel 1200), the first mode control signal SIG_mode1 may be in the logic low state and the second mode control signal SIG_mode2 may be in the logic high state. Here, the voltage boosting unit 1130 operates in the second operating mode. In exemplary embodiments of the present inventive concept, the boosting multiplier of the first operating mode is smaller than that of the second operating mode. In other words, when the load occurs in the display panel 1200, a decrease of output of the gate voltage VGH may be prevented by increasing the boosting multiplier of the gate voltage VGH.

In exemplary embodiments of the present inventive concept, the first and second mode control signals SIG_mode1 and SIG_mode2 may be complementary signals.

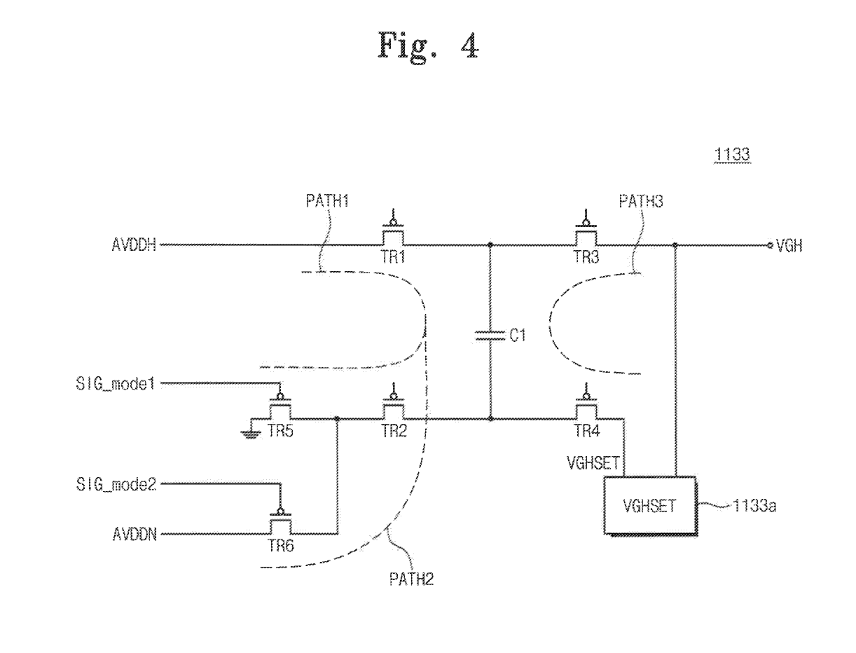

The charge pump 1133 may receive the first and second mode control signals SIG_mode1 and SIG_mode2 and the first and second input voltages AVDDH and AVDDN, and may output the gate voltage VGH based on the received first and second mode control signals SIG_mode1 and SIG_mode2 and the received first and second input voltages AVDDH and AVDDN. A configuration and an operation of the charge pump 1133 will be described in detail with reference to FIG. 4.

FIG. 4 is a circuit diagram illustrating the charge pump 1133 of FIG. 3, according to an exemplary embodiment of the present inventive concept. Referring to FIG. 4, the charge pump 1133 includes first to sixth transistors TR1 to TR6, a capacitor C1, and a gate adjusting voltage generating unit 1133a. The first to fourth transistors TR1 to TR4 may operate based on a switching signal received from an external device. For example, when the first and second transistors TR1 and TR2 are turned on, the third and fourth transistors TR3 and TR4 are turned off. At this time, the capacitor C1 may be charged along a first path PATH1 or a second path PATH2. On the contrary, when the first and second transistors TR1 and TR2 are turned off, the third and fourth transistors TR3 and TR4 are turned on. At this time, the capacitor C1 may be charged or discharged along a third path PATH3.

The first to fourth transistors TR1 to TR4 are repeatedly turned on and turned off to thereby charge the capacitor C1, as described above. In exemplary embodiments of the present inventive concept, a voltage charged in the capacitor C1 may be the gate voltage VGH.

The fifth transistor TR5 operates in response to the first mode control signal SIG_mode1. The sixth transistor TR6 operates in response to the second mode control signal SIG_mode2. For example, when the first mode control signal SIG_mode1 is in the logic high state (the first operating mode), a terminal of the capacitor C1 may be connected to a ground voltage GND. When the second mode control signal SIG_mode2 is in the logic high state (the second operating mode), the terminal of the capacitor C1 may be connected to the second input voltage AVDDN.

In other words, in the first operating mode, the capacitor C1 may be charged along the first path PATH1 and the third path PATH3. For example, the capacitor C1 is charged with the first input voltage AVDDH along the first path PATH1. Thereafter, the capacitor C1 is additionally charged with a gate adjusting voltage VGHSET along the third path PATH3. In this case, the gate voltage VGH may be expressed as Equation (1).

VGH=AVDDH+VGHSET (1)

Referring to Equation (1), in the first operating mode, the gate voltage VGH may range from the first input voltage AVDDH to a sum of the first input voltage and the gate adjusting voltage (AVDDH+VGHSET). For example, when the first input voltage AVDDH is about 5 V, the gate voltage VGH may range from about 5 V to about 10 V in the first operating mode.

However, in the second operating mode, the capacitor C1 is charged along the second path PATH2 and the third path PATH3. For example, the capacitor C1 is charged with the first and second input voltages AVDDH and AVDDN along the second path PATH2. Thereafter, the capacitor C1 is additionally charged with the gate adjusting voltage VGHSET along the third path PATH3. In this case, the gate voltage VGH may be expressed as Equation (2).

VGH=AVDDH+|AVDDN|+VGHSET (2)

Referring to Equations (1) and (2), the gate voltage VGH of the second operating mode may be higher than the gate voltage VGH of the first operating mode by as much as the second input voltage AVDDN. In other words, since the voltage boosting unit 1130 operates in the second operating mode when the load occurs in the display panel 1200, a decrease of output of the gate voltage VGH may be prevented.

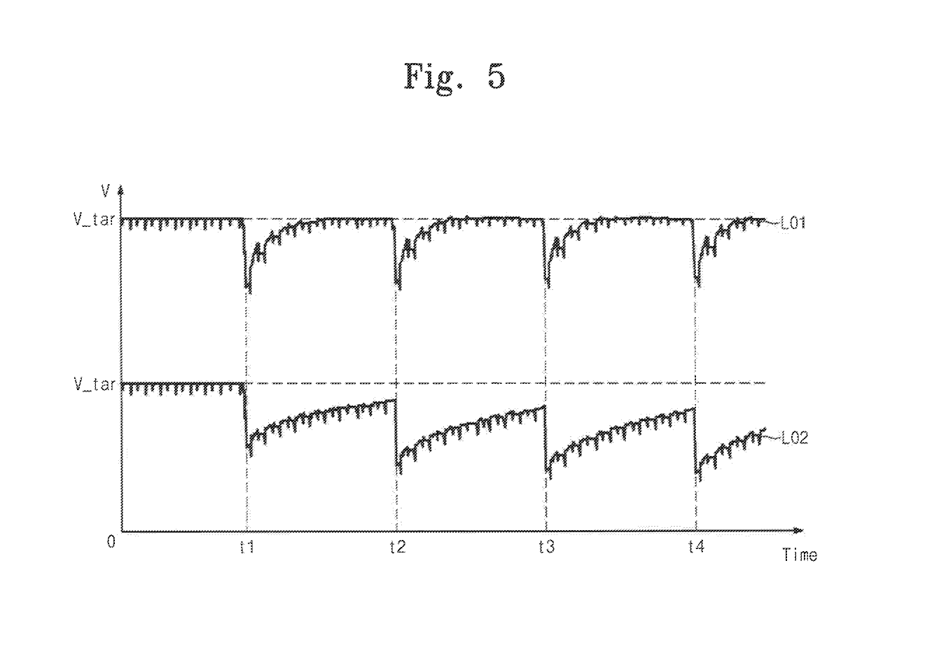

FIG. 5 is a graph illustrating the gate voltage VGH of FIG. 4, according to an exemplary embodiment of the present inventive concept. For example, the X axis of the graph represents time and the Y axis represents voltage. Referring to FIGS. 2 and 5, a first line L01 indicates the gate voltage VGH output from the voltage boosting unit 1130 according to an exemplary embodiment of the present inventive concept. A second line L02 indicates a gate voltage output from a typical voltage boosting unit. The load occurs in the display panel 1200 at first to fourth times t1 to t4. In this case, as indicated by the second line L02, the gate voltage VGH decreases at the first to fourth times t1 to t4 at which the load occurs, in the typical voltage boosting unit. Furthermore, after the occurrence of the load, a voltage drop occurs due to the occurrence of the load such that the gate voltage does not reach a target voltage V_tar. Therefore, the gate voltage output from the typical voltage boosting unit gradually decreases.

However, as indicated by the first line L01, the voltage boosting unit 1130 according to an exemplary embodiment of the present inventive concept changes the operating mode for a predetermined period of time at each of the first to fourth times t1 to t4. For example, the voltage boosting unit 1130 may operate in the second operating mode for the predetermined period of time from the first time t1. After a lapse of the predetermined period of time, the voltage boosting unit 1130 may operate in the first operating mode. In exemplary embodiments of the present inventive concept, the boosting multiplier of the second operating mode is greater than that of the first operating mode. When the gate voltage VGH decreases due to the occurrence of the load, the voltage boosting unit 1130 changes the operating mode (or increases the boosting multiplier), thereby reducing a time taken for the gate voltage VGH to reach the target voltage V_tar (e.g., recovery time). Therefore, the voltage efficiency of the DDI 1100 improves.

According to the above-described exemplary embodiment of the present inventive concept, the voltage boosting unit 1130 receives the gate control signal SIG_g from the control logic unit 1110. The voltage boosting unit 1130 may detect whether the load occurs in the display panel 1200 based on the gate control signal SIG_g, and may change the boosting multiplier of the gate voltage VGH. Therefore, a DDI with improved performance and a display system to which the DDI is applied are provided.

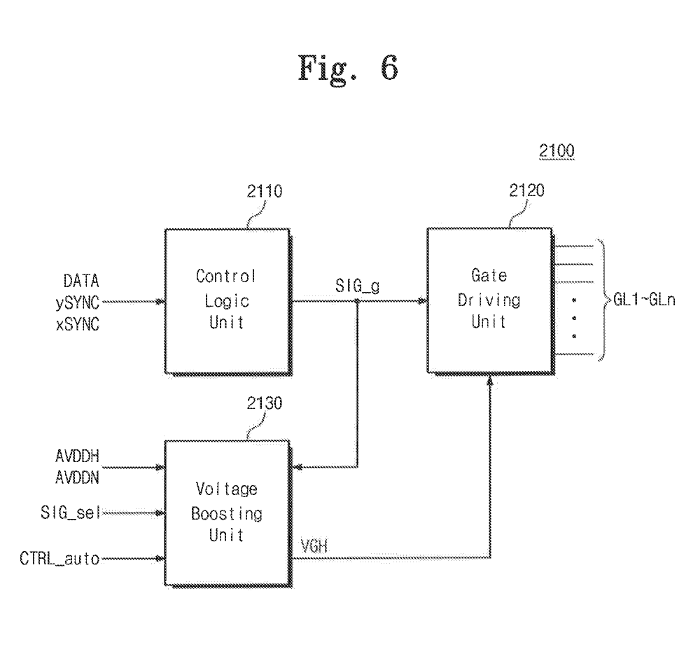

FIG. 6 is a block diagram illustrating a DDI according to an exemplary embodiment of the present inventive concept. Referring to FIG. 6, a DDI 2100 includes a control logic unit 2110, a gate driving unit 2120, and a voltage boosting unit 2130. The control logic unit 2110 and the gate driving unit 2120 correspond to those described with reference to FIG. 2. Therefore, detailed descriptions of these elements are omitted below.

Compared with the voltage boosting unit 1130 of FIG. 2, the voltage boosting unit 2130 of FIG. 6 further receives a selection signal SIG_sel and an automatic control signal CTRL_auto. The selection signal SIG_sel is used to select an operating mode of the voltage boosting unit 2130. The automatic control signal CTRL_auto is used to control a change of the operating mode of the voltage boosting unit 2130.

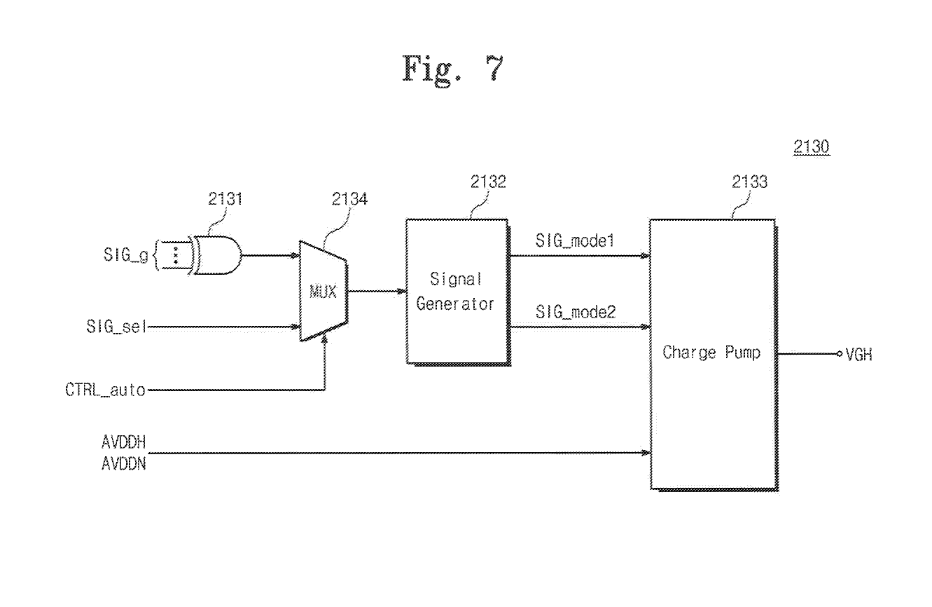

In exemplary embodiments of the inventive concept, when the automatic control signal CTRL_auto is in the logic low state, the operating mode of the voltage boosting unit 2130 may not be changed according to a change of an external load. On the contrary, when the automatic control signal CTRL_auto is in the logic high state, the operating mode of the voltage boosting unit 2130 may be changed according to the change of the external load. An operation of the voltage boosting unit 2130 will be described in detail with reference to FIG. 7.

FIG. 7 is a block diagram illustrating the voltage boosting unit 2130 of FIG. 6, according to an exemplary embodiment of the present inventive concept. Referring to FIG. 7, the voltage boosting unit 2130 includes an XOR gate 2131, a signal generator 2132, a charge pump 2133, and a multiplexer (MUX) 2134. The XOR gate 2131, the signal generator 2132, and the charge pump 2133 correspond to those described with reference to FIG. 3. Therefore, detailed descriptions of these elements are omitted below.

The MUX 2134 may receive a result of an operation of the XOR gate 2131 and the selection signal SIG_sel. The MUX 2134 may transfer one of the operation result of the XOR gate 2131 and the selection signal SIG_sel to the signal generator 2132 according to the automatic control signal CTRL_auto. For example, when the automatic control signal CTRL_auto is in the logic high state, the MUX 2134 may transfer the operation result of the XOR gate 2131 to the signal generator 2132, On the contrary, when the automatic control signal CTRL_auto is in the logic low state, the MUX 2134 may transfer the selection signal SIG_sel to the signal generator 2132.

In other words, the operating mode of the voltage boosting unit 2130 may he controlled by controlling the automatic control signal CTRL_auto and the selection signal SIG_sel. In exemplary embodiments of the present inventive concept, when a test of the DDI is performed, a specific operating mode may he required regardless of a change of the load in the display panel. In this case, a test operation of the DDI may be guaranteed by setting the operating mode of the voltage boosting unit 2130 based on the automatic control signal CTRL_auto and the selection signal SIG_sel.

According to the above-described an exemplary embodiment of the present inventive concept, the voltage boosting unit 2130 may set the operating mode based on the selection signal SIG_sel and the automatic control signal CTRL₋auto. In other words, the operating mode is changed according to the change of the load in the display panel, and the test mode of the DDI is further supported. Therefore, a DDI with improved performance and a display system to which the DDI is applied are provided.

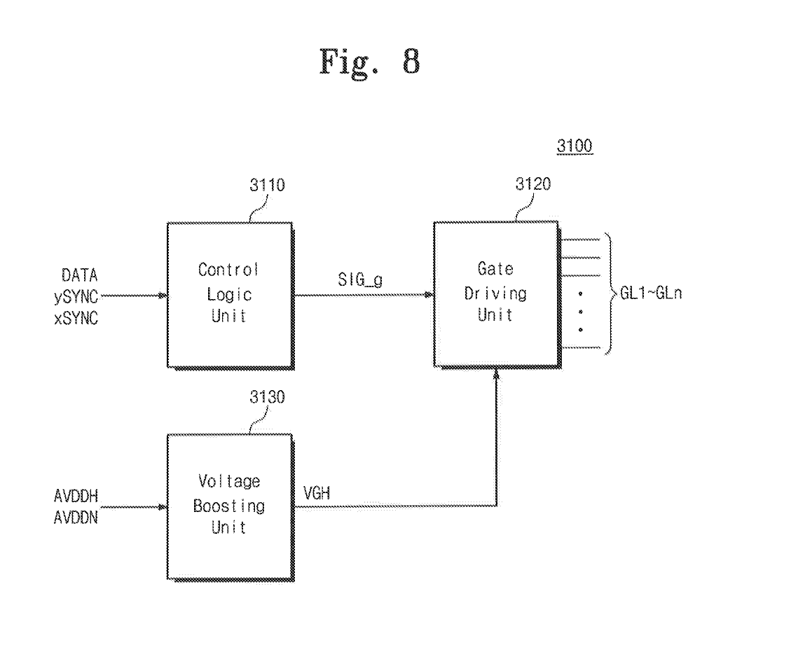

FIG. 8 is a block diagram illustrating a DDI according to an exemplary embodiment of the present inventive concept. Referring to FIG. 8, a DDI 3100 includes a control logic unit 3110, a gate driving unit 3120, and a voltage boosting unit 3130. The control logic unit 3110 and the gate driving unit 3120 correspond to those described with reference to FIG. 2. Therefore, detailed descriptions of these elements are omitted below.

Compared with the voltage boosting unit 1130 of FIG. 2, the voltage boosting unit 3130 of FIG. 8 does not receive the gate control signal SIG_g from the control logic unit 3110. The voltage boosting unit 3130 may detect a change of the gate voltage VGH and may change the operating mode (or boosting multiplier) based on the detected change of the gate voltage VGH.

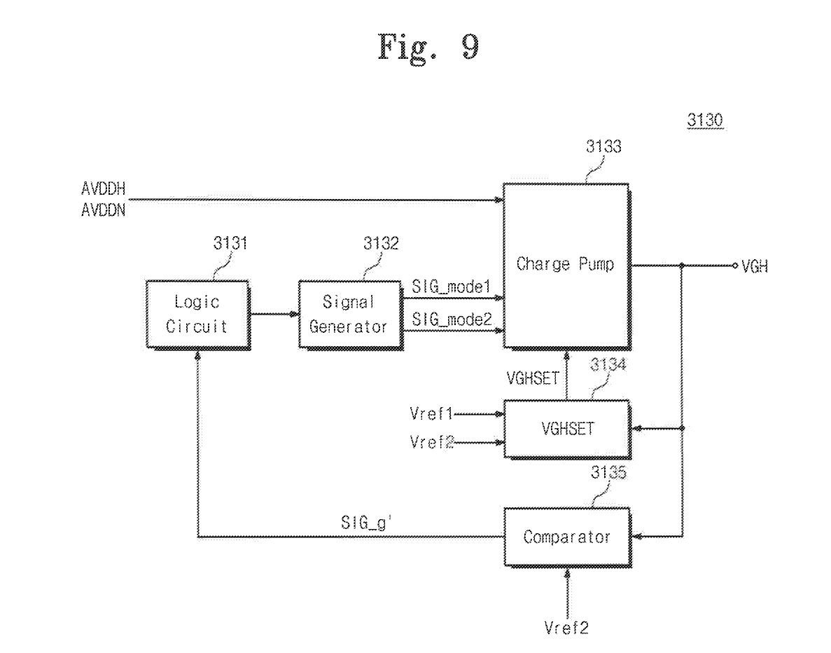

FIG. 9 is a block diagram illustrating the voltage boosting unit 3130 of FIG. 8, according to an exemplary embodiment of the inventive concept. Referring to FIG. 9, the voltage boosting unit 3130 includes a logic circuit 3131, a signal generator 3132, a charge pump 3133, a gate adjusting voltage generator 3134, and a comparator 3135. The signal generator 3132 and the charge pump 3133 correspond to those described with reference to FIG. 3. Therefore, detailed descriptions of these elements are omitted below.

The logic circuit 3131 receives a comparison signal SIG_g′ from the comparator 3135. The logic circuit 3131 may control the signal generator 3132 based on the received comparison signal SIG_g′.

The gate adjusting voltage generator 3134 may output the gate adjusting voltage VGHSET based on first and second reference voltages Vref1 and Vref2 and the gate voltage VGH. For example, when the voltage boosting unit 3130 operates in the first operating mode, the gate adjusting voltage generator 3134 may adjust the gate adjusting voltage VGHSET by comparing the first reference voltage Vref1 with the gate voltage VGH. When the voltage boosting unit 3130 operates in the second operating mode, the gate adjusting voltage generator 3134 may adjust the gate adjusting voltage VGHSET by comparing the second reference voltage Vref2 with the gate voltage VGH.

The comparator 3135 may compare the second reference voltage Vref2 with the gate voltage VGH and may transfer the comparison signal SIG_g′ to the logic circuit 3131. For example, the comparison signal SIG_g′ may be in the logic high state when the gate voltage VGH is lower than the second reference voltage Vref2 (or when the gate voltage VGH decreases due to the occurrence of a load).

According to the above-described exemplary embodiment of the inventive concept, the voltage boosting unit 3130 may compare the gate voltage VGH with the second reference voltage Vref2 to detect the occurrence of a load in a display panel. The voltage boosting unit 3130 may adjust the boosting multiplier of the gate voltage VGH based on a result of the detection.

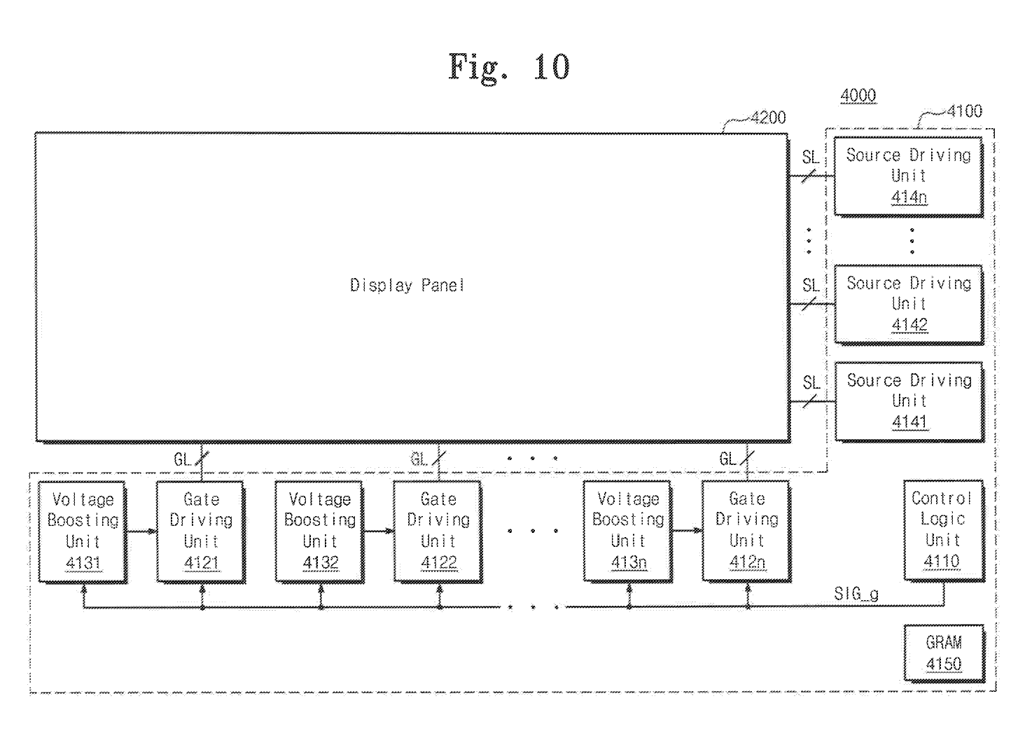

FIG. 10 is a block diagram illustrating a display system according to an exemplary embodiment of the inventive concept. Referring to FIG. 10, a display system 4000 includes a DDI 4100 and a display panel 4200. The display panel 4200 corresponds to that described with reference to FIG. 1. Thus, detailed descriptions of this element are omitted below.

The DDI 4100 includes a control logic unit 4110, a plurality of gate driving units 4121 to 412n, a plurality of voltage boosting units 4131 to 413n, a plurality of source driving units 4141 to 414n, and a GRAM 4150. Compared with the DDI 1100 of FIG. 1, the DDI 4100 of FIG. 10 includes the plurality of gate driving units 4121 to 412n, the plurality of voltage boosting units 4131 to 413n, and the plurality of source driving units 4141 to 414n. Each of the plurality of gate driving units 4121 to 412n is connected to a part of a plurality of gate lines GL connected to the display panel 4200. Each of the plurality of gate driving units 4121 to 412n may control the plurality of gate lines GL under control of the control logic unit 4110. The plurality of voltage boosting units 4131 to 413n supply the gate voltage VGH to the plurality of gate driving units 4121 to 412n respectively. Each of the plurality of source driving units 4141 to 414n is connected to a part of a plurality of source lines SL connected to the display panel 4200.

In exemplary embodiments of the present inventive concept, the control logic unit 4110 transfers a plurality of gate control signals SIG_g corresponding to the plurality of gate driving units 4121 to 412n to the plurality of voltage boosting units 4131 to 413n. The plurality of voltage boosting units 4131 to 413n may output the gate voltage VGH in the same manner as described above with reference to FIGS. 1 to 9.

According to the above-described exemplary embodiment of the inventive concept, the DDI 4100 includes the plurality of gate driving units 4121 to 412n and the plurality of voltage boosting units 4131 to 413n. The plurality of voltage boosting units 4131 to 413n may adjust boosting multipliers of gate voltages, and the plurality of gate driving units 4121 to 412n may operate based on the adjusted gate voltages. Therefore, a DDI with improved performance and a display system to which the DDI is applied are provided.

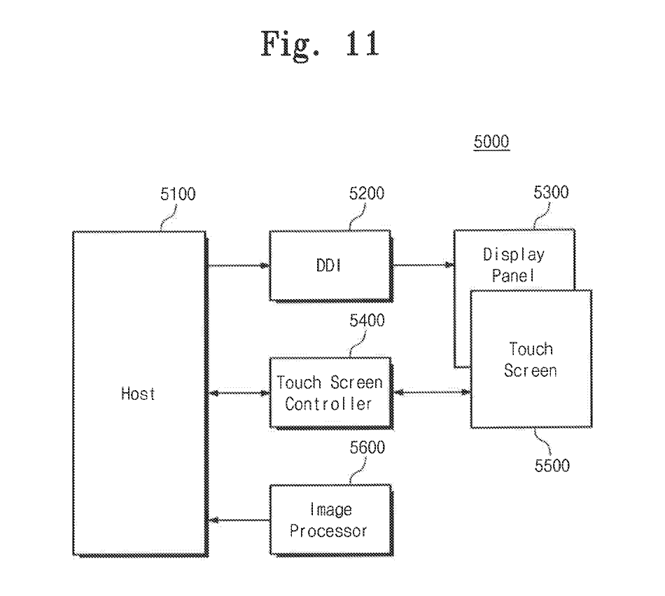

FIG. 11 is a block diagram illustrating a user system to which a DDI according to an exemplary embodiment of the inventive concept is applied. Referring to FIG. 11, a user system 5000 includes a host 5100, a DDI 5200, a display panel 5300, a touch screen controller 5400, a touch screen 5500, and an image processor 5600.

The host 5100 may receive data or a command from a user, and may control the DDI 5200 and the touch screen controller 5400 based on the inputted data or command. The DDI 5200 may drive the display panel 5300 under control of the host 5100. For example, the DIM 5200 may operate in the same or similar manner as described above with reference to FIGS. 1 to 9. The touch screen 5500 is arranged to overlap the display panel 5300. The touch screen controller 5400 may receive detection data from the touch screen 5500 and may transfer the data to the host 5100.

The image processor 5600 may receive image information from the host 5100 and process the received image information to generate image data. For example, the image processor 5600 may include image codec encoding or decoding the received image information such as JPEG (Joint Photography Experts Group), MPEG (Moving Picture Experts Group) codec, DivX (Digital Video Express) codec, H.264 codec, DV codec and so on.

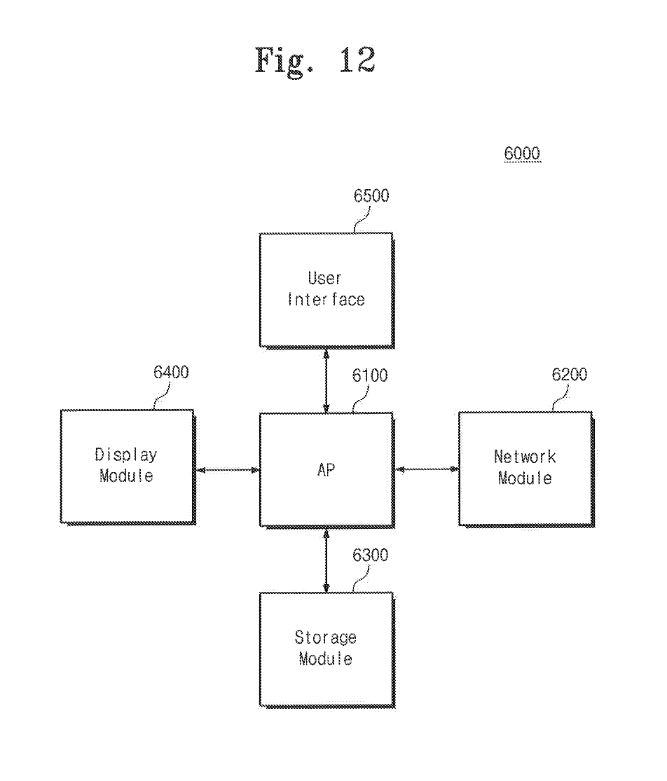

FIG. 12 is a block diagram illustrating a mobile system to which a DDI according to an exemplary embodiment of the inventive concept is applied. Referring to FIG. 12, a mobile system 6000 includes an application processor 6100, a network module 6200, a storage module 6300, a display module 6400, and a user interface 6500. For example, the mobile system 6000 may be one of computing systems such as ultra mobile PCs (UMPCs), workstations, net-books, personal digital assistants (PDAs), portable computers, web tablets, wireless phones, mobile phones, smart phones, e-books, portable multimedia players (PMPs), portable game machines, navigation devices, black boxes, digital cameras, digital multimedia broadcasting (DMB) players, digital audio recorders, digital audio players, digital picture recorders, digital picture players, digital video recorders, and digital video players.

The application processor 6100 may drive elements and an operating system (OS) of the mobile system 6000. For example, the application processor 6100 may include a graphic engine, an interface, and controllers for controlling the elements included in the mobile system 6000.

The network module 6200 may perform communication with external devices. For example, the network module 6200 may support communication schemes such as code division multiple access (CDMA), global system for mobile communication (GSM), wideband CDMA (WCDMA), CDMA-2000, time division multiple access (TDMA), long term evolution (LTE), Wimax, wireless local area network (WLAN), ultra wideband (UWB), Bluetooth, and Wi-Fi.

The storage module 6300 may store data. For example, the storage module 6300 may store data received externally. Furthermore, the storage module 6300 may transfer the data stored therein to the application processor 6100. For example, the storage module 6300 may include a semiconductor memory device such as a dynamic RAM (DRAM), a synchronous DRAM (SDRAM), a static RAM (SRAM), a double data rate SDRAM (DDR SDRAM), a DDR2 SDRAM, a DDR3 SDRAM, a phase-change RAM (PRAM), a magnetic RAM (MRAM), a NAND flash, or a NOR flash.

The display module 6400 may output image data under control of the application processor 6100. For example, the display module 6400 and the application processor 6100 may communicate based on a display serial interface (DSI). For example, the display module 6400 may include the DDI and the display panel described above with reference to FIGS. I to 9. The DDI included in the display module 6400 may operate in the same or similar manner as described above with reference to FIGS. 1 to 9.

The user interface 6500 provides an interface for inputting data or a command to the mobile system 6000. For example, the user interface 6400 may include input devices such as a camera, a touch screen, a motion recognition module, and a microphone, or output devices such as a speaker and a touch screen.

As described above, in accordance with an exemplary embodiment of the present inventive concept, the voltage boosting unit included in the DDI may change the operating mode (or the multiplier of the gate voltage) according to the change of the load in the display panel. The decrease of output of the gate voltage due to the load in the display panel may be prevented. Therefore, a DDI with improved performance and a display system including the same are provided. Furthermore, the voltage efficiency of the display system is improved, and the recovery time of the gate voltage is reduced.

While, the present inventive concept has been particularly shown and described with reference to exemplary embodiments thereof, it will be understood by those skilled in the art that various changes in form and detail may be made therein without departing from the spirit and scope of the present inventive concept as defined by the following claims.

What is claimed is:

1. A display driver integrated circuit, comprising:
a gate driving unit configured to control voltages of a plurality of gate lines connected to a display panel;
a voltage boosting unit configured to supply a gate voltage to the gate driving unit; and
a control logic unit configured to receive data, a horizontal synchronization signal, and a vertical synchronization signal, generate a gate control signal based on the data, the horizontal synchronization signal, and the vertical synchronization signal, and transfer the gate control signal to the gate driving unit and the voltage boosting unit,
wherein the voltage boosting unit is configured to adjust a level of the gate voltage based on the gate control signal.

2. The display driver integrated circuit of claim I, wherein the gate driving unit supplies the gate voltage to at least one of the plurality of gate lines based on the gate control signal.

3. The display driver integrated circuit of claim 2, wherein the voltage boosting unit is configured to increase the gate voltage when the gate voltage is applied to the at least one of the plurality of gate lines.

4. The display driver integrated circuit of claim 1, wherein the voltage boosting unit comprises:
an XOR gate configured to receive the gate control signal, perform an exclusive OR operation on the gate control signal and output an operation value as a result of the exclusive OR operation;
a signal generator configured to receive the operation value of the XOR gate and output first and second mode control signals based on the operation value; and
a charge pump configured to output the gate voltage based on the first and second mode control signals,
wherein the first and second mode control signals are complementary signals.

5. The display driver integrated circuit of claim 4, wherein the charge pump is configured to output a first gate voltage when the first mode control signal is in a first state, and output a second gate voltage when the second mode control signal is in the first state, wherein the first gate voltage is lower than the second gate voltage.

6. The display driver integrated circuit of claim 1, further comprising:
a source driving unit configured to control a current of a plurality of source lines connected to the display panel under control of the control logic unit; and
a graphic random access memory (RAM) configured to support a serial interface between an external device and the display driver integrated circuit.

7. The display driver integrated circuit of claim 1, wherein the voltage boosting unit is configured to receive an automatic control signal and a mode selection signal, to adjust an operating mode of the voltage boosting unit based on the automatic control signal and the mode selection signal, and to adjust the level of the gate voltage based on the adjusted operating mode.

8. The display driver integrated circuit of claim 7, wherein the voltage boosting unit is configured to adjust a boosting multiplier based on the mode selection signal when the automatic control signal is in a first state, and the voltage boosting unit is configured to adjust the level of the gate voltage based on the gate control signal when the automatic control signal is in a second state.

9. A display system, comprising:
a display panel connected to a plurality of gate lines and a plurality of source lines; and
a display driver integrated circuit configured to control a voltage of the plurality of gate lines and a current of the plurality of source lines,
wherein the display driver integrated circuit is configured to receive an image signal, to generate a gate control signal based on the image signal, and to adjust a level of a gate voltage to be supplied to the plurality of gate lines based on the gate control signal.

10. The display system of claim 9, wherein the display driver integrated circuit comprises:
a control logic unit configured to output the gate control signal based on the image signal;
a gate driving unit configured to control the voltage of the plurality of gate lines based on the gate control signal; and
a voltage boosting unit configured to adjust the level of the gate voltage based on the gate control signal.

11. The display system of claim 10, wherein the gate control signal comprises control signals corresponding to the plurality of gate lines respectively.

12. The display system of claim 11, wherein the gate voltage is supplied to at least one of the plurality of gate lines when a result of an exclusive OR operation on the gate control signal is a first value, and the display driver integrated circuit is configured to increase the level of the gate voltage when the gate control signal is in a first state.

13. The display system of claim 10, wherein the display driver integrated circuit further comprises a source driving unit configured to control a current of at least one of the plurality of source lines.

14. The display system of claim 10, wherein the display driver integrated circuit further comprises a graphic random access memory (RAM) configured to support a serial interface with an external device.

15. The display system of claim 9, wherein the display panel includes an organic light emitting display panel, a liquid crystal display panel, a plasma display panel, an electrophoretic display panel, or an electrowetting display panel.

16. A display driver integrated circuit, comprising:
a control logic unit configured to generate a gate control signal in response to image information;
a voltage boosting unit configured to output a gate voltage in response to first and second input voltages and adjust a boosting multiplier of the gate voltage in response to the gate control signal received from the control logic unit; and
a gate driving unit configured to receive the gate voltage from the voltage boosting unit and output the gate voltage in response to the gate control signal received from the control logic, unit.

17. The display driver integrated circuit of claim 16, wherein the boosting multiplier of the gate voltage is adjusted when a load occurs in a display panel.

18. The display driver integrated circuit of claim 17, wherein the boosting multiplier is increased when it is adjusted.

19. The display driver integrated circuit of claim 16, wherein the voltage boosting unit includes a logic gate configured to receive the gate control signal.

20. The display driver integrated circuit of claim 19, wherein the voltage boosting unit includes a charge pump configured to receive the first and second input voltages and to receive a mode control signal generated in response to an output of the logic gate.
